(19) United States
(12) Patent Application Publication
(10) Pub. No.: US 2024/0162641 A1
(43) Pub. Date: May 16, 2024

(54) ELECTRICAL CONNECTOR

(71) Applicant: Hirose Electric Co., Ltd., Yokohama (JP)

(72) Inventors: Ryo YOKOYAMA, Yokohama (JP); Naoki NINOMIYA, Yokohama (JP)

(21) Appl. No.: 18/502,283

(22) Filed: Nov. 6, 2023

(30) Foreign Application Priority Data
Nov. 8, 2022 (JP) 2022-178539

(51) Int. Cl. H01R 12/71; H01R 13/02; H01R 13/508

(52) U.S. Cl. CPC H01R 12/716; H01R 13/025; H01R 13/508

(57) ABSTRACT

An electrical connector 10 disposed on a circuit board 1 covered by an electrically conductive cover 70, the connector comprising an electrically conductive tubular outer conductor 11 mounted on the circuit board 1 and extending axially along the direction of mating Z with a counterpart electrical connector 20, 40, and an electrically conductive supporting portion 14 provided in the outer conductor 11 and having a connection portion at the top in the direction of mating Z, wherein the connection portion of the supporting portion 14 and the cover 70 are brought into direct or indirect contact when the circuit board 1 is covered by the cover 70, thereby electrically connecting the electrical connector 10 and the cover 70.

### CROSS-REFERENCE TO RELATED APPLICATIONS

This application claims priority to Japanese Patent Application No. 2022-178539, filed Nov. 8, 2022, the contents of which are incorporated herein by reference in its entirety for all purposes.

### TECHNICAL FIELD

The present invention relates to electrical connectors and, in particular, to an electrical connector coupled to ground.

### BACKGROUND ART

A technology in which a circuit board processing radio-frequency signals is covered with an electrically conductive housing in order to electromagnetically shield the circuit board has been known in the past (e.g., see Patent Document 1). In the device described in Patent Document 1, the housing and the ground conductor of the circuit board are adapted to be electrically connected once the circuit board is accommodated within the housing.

Furthermore, an electrical connector is attached to the circuit board in the device of Patent Document 1. The electrical connector is provided with a cylinder-shaped outer conductor and a center conductor coaxial therewith. A circular through-opening with an inside diameter slightly larger than the outside diameter of the outer conductor of the electrical connector is provided in the cover of the housing. The electrical connector is adapted to be exposed to the exterior via the through-opening when the circuit board is accommodated within the housing. Specifically, when the outer conductor and center conductor of the electrical connector are inserted into the through-opening of the housing, the distal end portion of the outer conductor is generally flush with the cover of the housing. The user can connect a counterpart electrical connector to the electrical connector through this through-opening. In the device of Patent Document 1, such a construction prevents electromagnetic noise generated by the circuit board from leaking out of the housing.

### PATENT DOCUMENTS

### [Patent Document 1]

Japanese Published Patent Application No. 2019-175893.

### SUMMARY

### Problems to be Solved

In the device of Patent Document 1, the outer conductor of the electrical connector attached to the circuit board is connected to the ground conductor of the circuit board and maintained at the ground potential. In addition, the housing is also connected to the ground conductor of the circuit board and placed at the ground potential. The inventors of the present Application have found, however, that in devices provided with such a circuit board for radio-frequency signals, components on the circuit board may malfunction because of differences in local ground potential around the periphery of the electrical connector.

The present invention, which was devised to eliminate the above-described issues, has the object of providing an electrical connector capable of achieving an improvement in the ground potential of an electrical connector attached to a circuit board.

### Technical Solution

An electrical connector according to one embodiment of the present invention is an electrical connector disposed on a circuit board covered by an electrically conductive cover, the connector comprising an electrically conductive tubular outer conductor mounted on the circuit board and extending axially along the direction of mating with a counterpart electrical connector, and an electrically conductive supporting portion provided in the outer conductor and having a connection portion at the top in the direction of mating, wherein, when the circuit board is covered by the cover, the connection portion of the supporting portion and the cover are brought into direct or indirect contact, thereby electrically connecting the electrical connector and the cover.

### Technical Effect

The present invention can provide an electrical connector capable of achieving an improvement in the ground potential of an electrical connector attached to a circuit board.

### BRIEF DESCRIPTION OF THE DRAWINGS

FIG. 1 is an exploded perspective view of an electronics module according to an embodiment of the present invention.

FIG. 2 is a partial enlarged cross-sectional perspective view of an electronics module according to an embodiment of the present invention.

FIG. 3 is a partial enlarged cross-sectional view of an electronics module according to an embodiment of the present invention.

FIG. 4 is a partial cross-sectional view of an electrical connector according to an embodiment of the present invention.

FIG. 5 is a lateral view of an electrical connector assembly according to an embodiment of the present invention.

FIG. 6 is a cross-sectional illustrative view of FIG. 5.

FIG. 7 is a lateral view of another electrical connector assembly according to an embodiment of the present invention.

FIG. 8 is cross-sectional illustrative view of FIG. 7.

FIGS. 9 (A) and 9 (B) are illustrative lateral views of an electrical connector according to a modification example of an embodiment of the present invention.

### DETAILED DESCRIPTION

Embodiments of the present invention will be described hereinbelow with reference to drawings. It should be noted that, in principle, same reference numerals are applied to the same parts in all the drawings used to illustrate the embodiments, and any further descriptions thereof are omitted. In addition, although each embodiment is described independently, this does not exclude the possibility of configuring the electrical connector by combining the respective components.

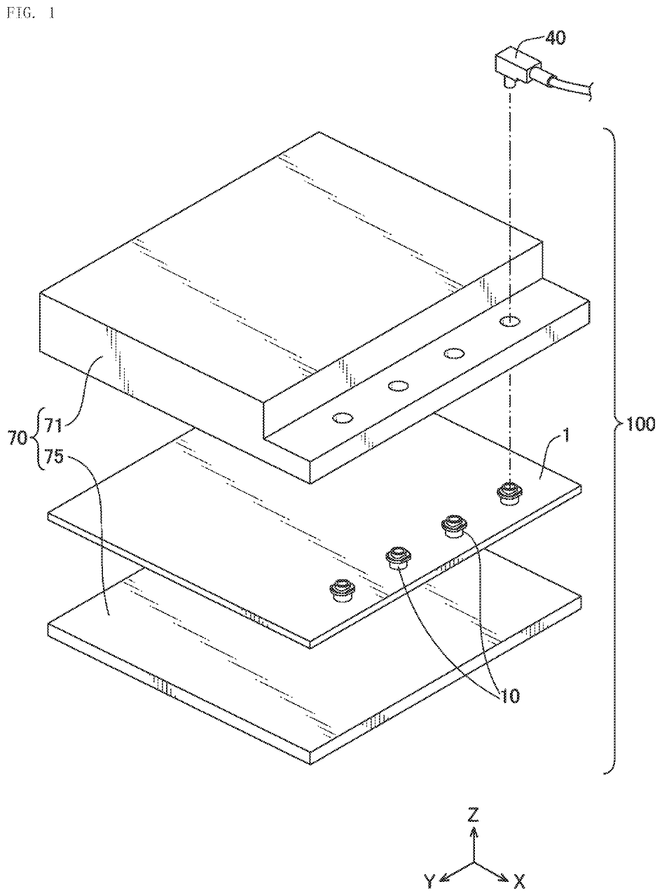

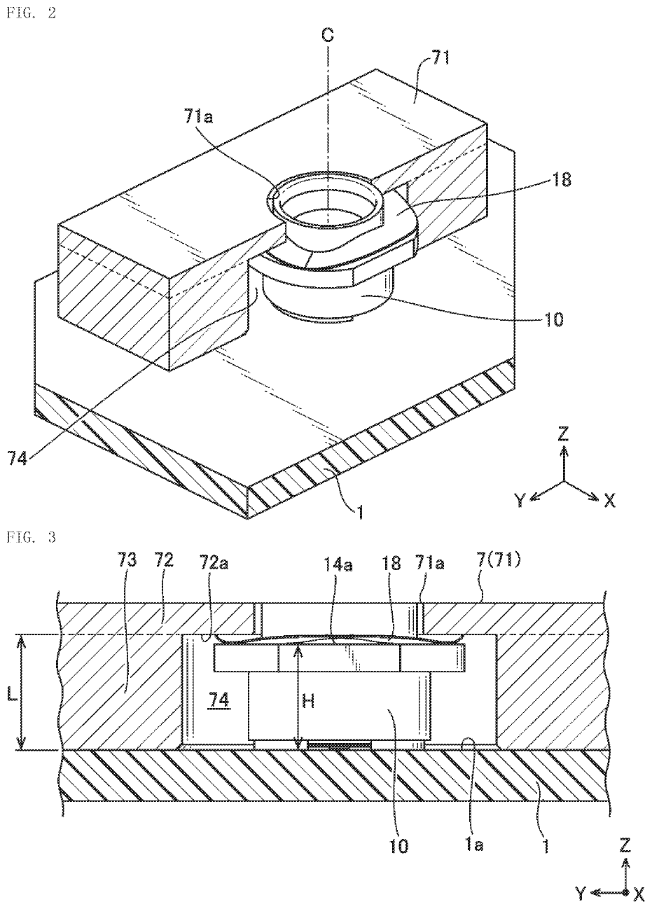

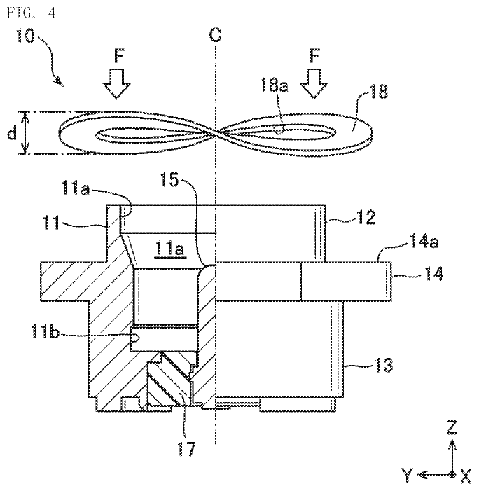

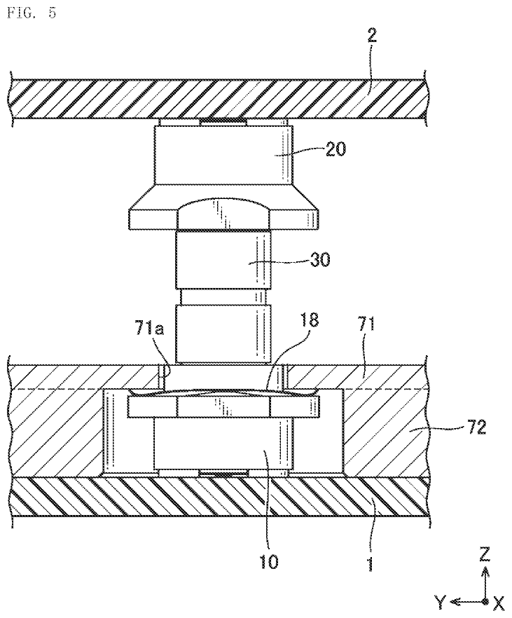

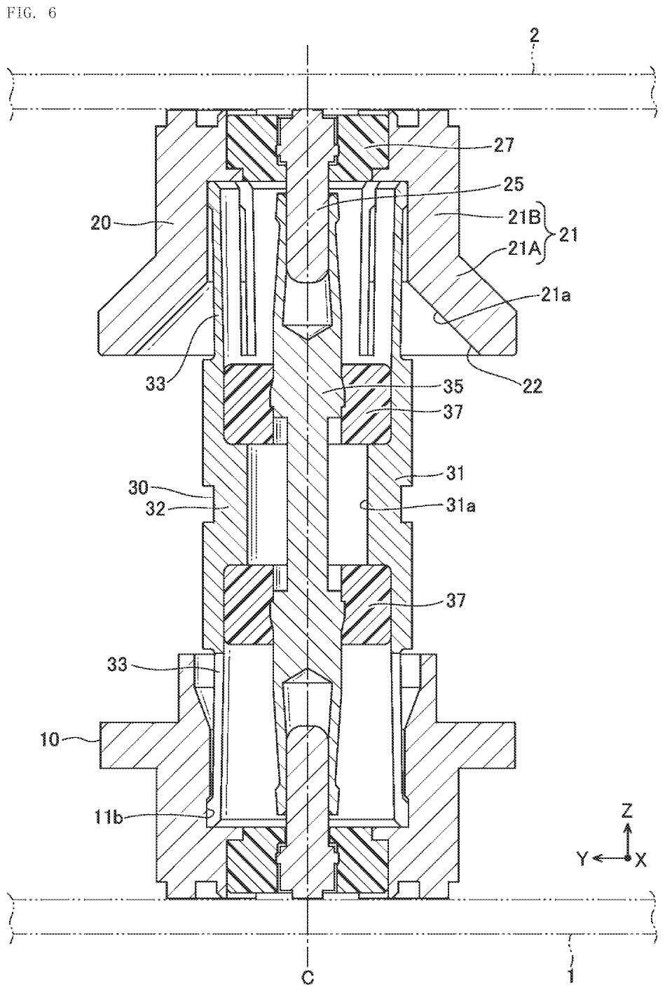

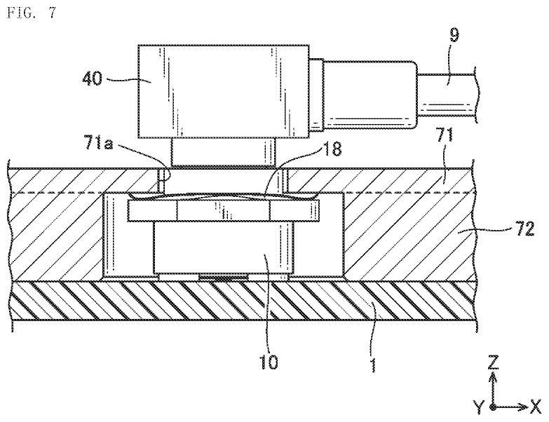

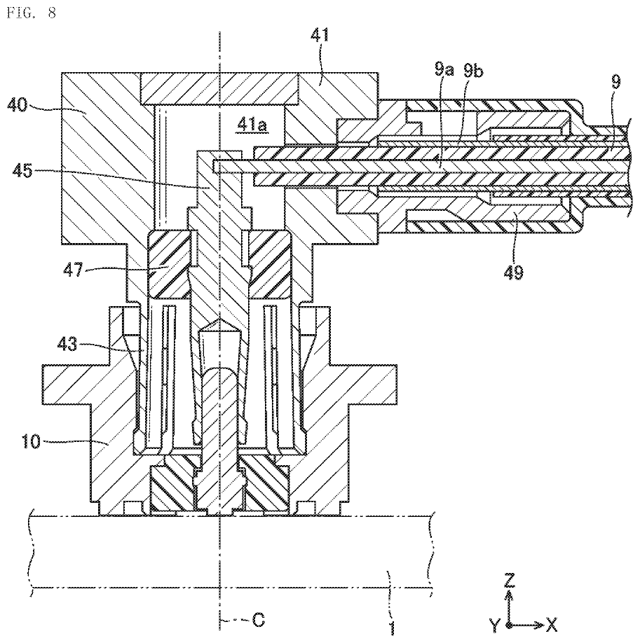

First, the configuration of an electronics module according to an embodiment of the present invention will be described with reference to FIGS. 1-8. FIG. 1 is an exploded perspective view of the electronics module, FIG. 2 is a partial enlarged cross-sectional perspective view of the electronics module, and FIG. 3 is a partial enlarged cross-sectional view of the electronics module. FIG. 4 is a partial cross-sectional view of an electrical connector, FIG. 5 is a lateral view of an electrical connector assembly, FIG. 6 is a cross-sectional illustrative view of FIG. 5, FIG. 7 is a lateral view of another electrical connector assembly, and FIG. 8 is a cross-sectional illustrative view of FIG. 7.

As shown in FIG. 1, the electronics module 100 according to an embodiment of the present invention is, for instance, an antenna device included in 5G base station equipment or the like. The electronics module 100 comprises a circuit board 1 having mounted thereon integrated circuits, etc., for processing radio-frequency signals, and a cover 70 that shields and covers the periphery of the circuit board 1. Multiple (four in FIG. 1) electrical connectors 10 are mounted on the circuit board 1 by solder or the like. Each electrical connector 10 is configured to be mated with a counterpart electrical connector (e.g., electrical connector 40) connected to an antenna element.

The cover 70, which is formed of an electrically conductive material (a metallic material, an electrically conductive plastic material, and the like), comprises a top cover 71, which covers the surface of the circuit board 1, and a bottom cover 75, which covers the back side. With the circuit board 1 sandwiched therebetween, the top cover 71 and bottom cover 75 are secured with screws, etc. (not shown). In addition, the top cover 71 and bottom cover 75 are configured to make contact with the ground conductor (not shown) of the circuit board 1 once the circuit board 1 is covered, thereby coupling the cover 70 to ground potential. The ground conductor is provided, for example, in a ground layer among the multiple layers constituting the circuit board 1, or on the back side, mounting face, etc., thereof. The top cover 71 and bottom cover 75 are directly or indirectly, via electrically conducting lines, connected to the ground conductor.

FIG. 2 illustrates the electronics module 100 with a partial cutout. As shown in FIG. 2, the electrical connector 10, which is of a generally cylindrical outer shape, is mounted on the circuit board 1 such that the axial direction along its central axis C is parallel to the vertical direction Z normal to the mounting plane (XY plane) of the circuit board 1. Specifically, electrical connector 10 is disposed on pads on the circuit board 1 and is attached to the pads by solder. It should be noted that although herein, for ease of understanding, the direction of mating used when coupling the electrical connector 10 to a counterpart electrical connector is defined as the vertical direction Z (or the direction of mating Z), the vertical direction Z and the direction of mating Z are not necessarily directions normal to the ground.

A generally circular column-shaped accommodating space 74 and an attachment opening 71a are provided for each electrical connector 10 in the top cover 71. When the top cover 71 is attached to the circuit board 1, each electrical connector 10 is accommodated within a corresponding accommodating space 74, with the top portion of the electrical connector 10 exposed through the attachment opening 71a. In the example of FIG. 3, the distal end portion of the electrical connector 10 is flush with the surface of the top cover 71.

As shown in FIG. 3, the top cover 71 has an upper plate portion 72 extending parallel to and above the circuit board 1, and a wall portion 73 extending downwardly from the upper plate portion 72 in a manner to form an accommodating space 74. The upper plate portion 72 and wall portion 73 may be either an integrally formed structure or separate members. In the present embodiment, the top portion of the accommodating space 74 is sealed because the upper plate portion 72 projects from the wall portion 73 surrounding the accommodating space 74 in the horizontal direction (XY direction) above the accommodating space 74. In addition, the accommodating space 74 is configured to be placed in communication with the exterior by forming an attachment opening 71a, which is a through-opening, in the section of the upper plate portion 72 that seals the top portion of the accommodating space 74.

As shown in FIG. 4, the electrical connector 10 comprises a generally circular cylinder-shaped outer conductor 11, a center conductor 15 disposed coaxially in a recess portion 11a within the outer conductor 11, a disk-shaped securing portion 17 securing the center conductor 15 in an electrically insulated relationship with respect to the outer conductor 11, and an annular resilient member 18. The outer conductor 11, center conductor 15, and resilient member 18 are formed of an electrically conductive material (e.g., metal), and the securing portion 17 is formed of an electrically insulating material. When the electrical connector 10 is mounted on pads on the circuit board 1, the outer conductor 11 is connected via the pads to the ground conductor of the circuit board 1, and the center conductor 15 is connected via the pads to signal lines on the circuit board 1.

The outer conductor 11 extends axially along the central axis C from the proximal end side attached to the circuit board 1 toward the distal end side where a counterpart electrical connector is inserted. A distal end portion 12 and a proximal end portion 13 of a generally cylindrical outer diameter are provided on the distal end side and proximal end side of the outer conductor 11. The distal end portion 12 is formed of a smaller outside diameter than the proximal end portion 13. In addition, between the distal end portion 12 and proximal end portion 13, there is provided a supporting portion 14 that extends from the radially outward lateral face of the outer conductor 11 (or proximal end portion 13), radially outwardly of the distal end portion 12 and proximal end portion 13. In the present embodiment, the supporting portion 14 is a flange.

The resilient member 18, which is a thin plate-shaped annular member consisting of an electrically conductive material, has a through-opening 18a into which the distal end portion 12 is inserted. Therefore, the resilient member 18 can be disposed on the connection portion 14a, i.e. the top face of the supporting portion 14 or a supporting surface, in such a manner that the distal end portion 12 passes through the through-opening 18a. The connection portion 14a is configured to support external forces acting in the direction of mating Z. In the present embodiment, the resilient member 18, which is a wave washer, has a continuous annular configuration in which electrically conductive resilient material is bent in an undulating manner in the vertical direction when viewed from the lateral side, and has a height dimension d in its natural state. Therefore, when an external force F is applied in a manner to compress the resilient member 18 in the thickness direction (the vertical direction Z in FIG. 4), the resilient member 18 is resiliently compressed from its natural state to a compressed state, and its height becomes smaller than d. In the compressed state, the resilient member 18 generates a resilient force acting in the vertical direction Z as a reaction force.

It should be noted that although in the present embodiment the resilient member 18 is a wave washer, this does not have to be the case, and the resilient member 18 may be a wave washer, a disk spring, a coil spring, a spring washer, a leaf spring, electrically conductive resin, electrically conductive rubber, or electrically conductive foam, or a combination thereof. Since all of these are electrically conductive and capable of resilient deflection in the vertical direction Z, they can be electrically connected while in resilient abutment therewith between the connection portion 14a of the electrical connector 10 and the bottom face 72a of the upper plate portion 72 of the top cover 71.

In addition, as long as the resilient member 18 has a shape that allows for the connection portion 14a and the bottom face 72a of the upper plate portion 72 to be maintained in a state of resilient abutment, it does not have be of a generally annular outer shape and, in addition, may be made up of multiple components. In addition, the resilient member 18 may be attached to the outer conductor 11 of the electrical connector 10 in an integral or non-detachable manner using welding or a separate retention feature and the like, or may be a separate component. Furthermore, the resilient member 18 may be disposed so as to be integral with the cover 70.

As shown in FIG. 3, in the electronics module 100, the electrical connector 10 is mounted on the circuit board 1, whereupon the cover 70 is attached in a manner to cover the circuit board 1. The height dimension d of the resilient member 18 in its natural state is set greater than the length obtained by subtracting the height H between the mounting face 1a of the circuit board 1 and the connection portion 14a of the electrical connector 10 from the length L between the mounting face 1a and the bottom face 72a of the upper plate portion 72 (i.e., L-H).

Therefore, in the attached state illustrated in FIG. 3, the resilient member 18 is compressed between the connection portion 14a of the supporting portion 14 and the bottom face 72a of the upper plate portion 72 of the top cover 71 in resilient abutment with the top and bottom faces 14a, 72a. Thus, in the electronics module 100 of the present embodiment, the electrical connector 10 and the cover 70 are configured to be directly electrically connected via the resilient member 18.

FIGS. 5 and 6 show the electrical connector 10 connected to a counterpart electrical connector 20 through the medium of an adaptor 30. It should be noted that illustration of the cover 70, etc., is omitted in FIG. 6. The counterpart electrical connector 20 is mounted on the mounting face of another circuit board 2. As shown in FIG. 6, the electrical connector 20 is shaped similar to the electrical connector 10. The electrical connector 20 comprises a generally circular cylinder-shaped outer conductor 21, a center conductor 25 disposed coaxially with the outer conductor 21 within a recess portion 21a in the outer conductor 21, and a securing portion 27 securing the center conductor 25 in an electrically insulated relationship with respect to the outer conductor 21. The outer conductor 21 comprises an increased-diameter portion 21A, whose distal end side (lower side in FIG. 6) expands in diameter towards the distal end, and a barrel portion 21B on the proximal end side, which is mounted on the circuit board 2. The outer conductor 21 and center conductor 25 are formed of an electrically conductive material (e.g., metal), and the securing portion 27 is formed of an electrically insulating material.

The adaptor 30, which has a generally cylindrical outer shape, comprises a central outer barrel portion 31, a center conductor portion 35 disposed coaxially with the outer barrel portion 31 in an interior space 31a within the outer barrel portion 31, and securing portions 37 securing the center conductor portion 35 in an electrically insulated relationship with respect to the outer barrel portion 31. The outer barrel portion 31 and the center conductor portion 35 are formed of an electrically conductive material (e.g., metal), and the securing portions 37 are formed of an electrically insulating material. The outer barrel portion 31 comprises a generally cylinder-shaped supporting portion 32 located in the center in the vertical direction, and multiple resilient engagement portions 33 respectively extending from the supporting portion 32 in the vertical direction. The multiple (in the present example, four) resilient engagement portions 33 are formed in the circumferential direction, with adjacent resilient engagement portions 33 separated by slits. With such an arrangement, the resilient engagement portions 33 can be resiliently deflected in the radial direction.

As shown in FIG. 6, an expanded recess portion 11b used for locking the distal end sections of the resilient engagement portions 33 of the adaptor 30 is formed in the bottom portion of the recess portion 11a in the electrical connector 10, and no expanded recess portion is formed in the electrical connector 20. In addition, the electrical connector 20 has a guiding surface 22 obtained as the increased-diameter portion 21A expands in diameter towards the distal end for guiding the resilient engagement portions 33 of the adaptor 30, but no guiding surface is formed in the electrical connector 10.

As shown in FIG. 5, when the electrical connector 10 is coupled to the counterpart electrical connector 20 through the medium of the adaptor 30, the electrical connector 10 is covered by the cover 70 and is practically invisible from outside. In addition, when it is coupled to the electrical connector 20, the electrical connector 10 is electrically connected to the cover 70 through the medium of the resilient member 18.

Further, FIGS. 7 and 8 show the electrical connector 10 connected to a counterpart electrical connector 40. It should be noted that illustration of the cover 70, etc., is omitted in FIG. 8. The counterpart electrical connector 40 is connected to a coaxial cable 9. As shown in FIG. 8, the electrical connector 40 comprises a generally circular cylinder-shaped outer conductor portion 41, a center conductor 45 disposed coaxially with the outer conductor portion 41 in a recess portion 41a within the outer conductor portion 41, a securing portion 47 securing the center conductor 45 in an electrically insulated relationship with respect to the outer conductor portion 41, and a securing member 49 supporting the coaxial cable 9 and securing it to the outer conductor portion 41. The outer conductor portion 41, center conductor 45, and securing member 49 are formed of an electrically conductive material (e.g., metal), and the securing portion 47 is formed of an electrically insulating material.

The bottom portion of the outer conductor portion 41 is similar in construction to the adaptor 30. Namely, the outer conductor portion 41 has multiple resilient engagement portions 43 separated by slits similar to the resilient engagement portions 33 of the adaptor 30, which makes it possible to mate with the electrical connector 10.

The center conductor 9a of the coaxial cable 9 is connected to the upper end of the center conductor 45 by solder or the like. On the other hand, the outer conductor 9b of the coaxial cable 9 is connected to the securing member 49 by solder or the like.

As shown in FIG. 7, when the electrical connector 10 is coupled to the counterpart electrical connector 40, the electrical connector 10 is covered by the cover 70 and is practically invisible from outside. In addition, when it is coupled to the electrical connector 40, the electrical connector 10 is electrically connected to the cover 70 through the medium of the resilient member 18.

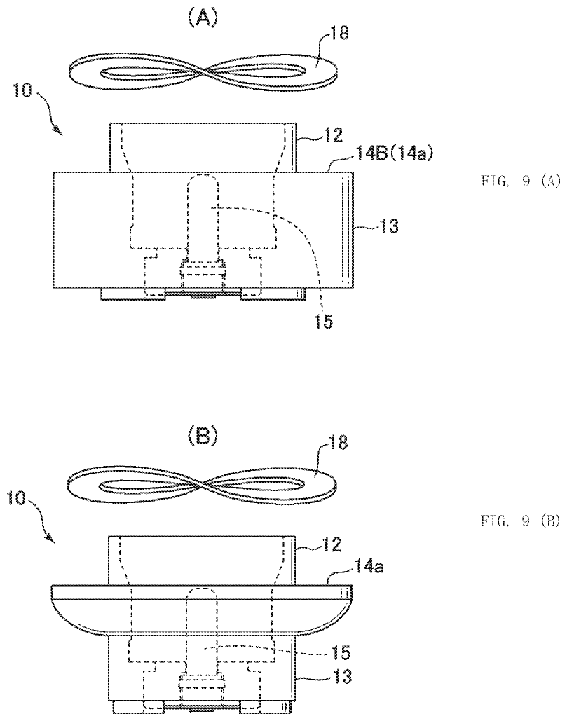

A modification to the present embodiment will be described below. There is no flange-like supporting portion 14 provided in the electrical connector 10 illustrated in FIG. 9 (A). However, the outside diameter of the proximal end portion 13 is set to be greater than the outside diameter of the distal end portion 12, thereby forming a stepped portion 14B. In the electrical connector 10 of FIG. 9 (A), this allows for the top face of the proximal end portion 13 to serve as a connection portion 14a and for the resilient member 18 to be disposed on this connection portion 14a. In addition, in the electrical connector 10 illustrated in FIG. 9 (B), the outside diameter of the distal end portion 12 and the outside diameter of the proximal end portion 13 are identically formed. A flange-like supporting portion 14, albeit formed in this manner, can be used for placement of the resilient member 18.

In addition, although in the embodiment described above the electrical connector 10 has a configuration in which the connection portion 14a of the supporting portion 14 makes indirect contact with the upper plate portion 72 of the cover 70 through the medium of the resilient member 18, this does not have to be the case, and the electrical connector 10 may have a configuration in which the connection portion 14a makes direct contact with the upper plate portion 72. In such a case, the connection portion 14a preferably comprises, for example, one or more upwardly protruding projections or ridges formed on the top face of the supporting portion 14. It should be noted that, conversely to the above, one or more downwardly protruding projections or ridges may be provided on the upper plate portion 72. Furthermore, the contact pressure or resilient force generated vis-a-vis the upper plate portion 72 or connection portion 14a can be adjusted by setting the height of the projections or ridges as appropriate. For example, referring to FIG. 3, the height of the projections or ridges can be set to dimensions equal to or greater than (L−H).

In addition, if no projections or ridges are provided, the height H of the top face of the connection portion 14a can be set to be greater than length L (H>L). In any case, when the cover 70 is attached, the connection portion 14a and upper plate portion 72 can be brought into pressurized contact. Further, the upper plate portion 72 is preferably an electrically conductive member permitting a certain degree of resilient displacement. In such a case, once the cover 70 is attached, the electrical connector 10 can be placed into a state in which the upper plate portion 72 applies resilient pressure to the connection portion 14a under a predetermined contact pressure because the connection portion 14a abuts the upper plate portion 72 and resiliently deforms the upper plate portion 72.

In addition, although an electrical connector 10 with a locking feature was used as an example in the embodiment described above, the present invention may be applied to an electrical connector 20 without a locking feature (see FIGS. 5, 6) instead of the electrical connector 10. For example, this may be a configuration in which the electrical connector 20 has a connection portion. In such a case, providing a cover to the circuit board 2 on which the electrical connector 20 is mounted also allows for the cover and the electrical connector 20 to be electrically connected directly or indirectly through the medium of the resilient member 18.

In addition, although in the embodiment described above the outer conductor 11, which is maintained at the ground potential of the circuit board 1, is of a generally cylindrical outer shape, this does not have to be the case, and, as long as it has a tubular configuration, it may be shaped to have a generally rectangular cross-section, a polygonal cross-section, and the like.

The operation and effects of the electrical connector 10 according to the present embodiment described above will be described below. The electrical connector 10 according to the present embodiment is an electrical connector 10 disposed on a circuit board 1 covered by an electrically conductive cover 70, the connector comprising an electrically conductive tubular outer conductor 11 mounted on the circuit board 1 and extending axially along the direction of mating Z with a counterpart electrical connector 20, 40, and an electrically conductive supporting portion 14 provided in the outer conductor 11 and having a connection portion 14a at the top in the direction of mating Z, wherein, when the circuit board 1 is covered by the cover 70, the connection portion 14a of the supporting portion 14 and the cover 70 are brought into direct or indirect contact, thereby electrically connecting the electrical connector 10 and the cover 70.

In accordance with the thus-configured present embodiment, once the circuit board 1 is covered by the cover 70, the connection portion 14a of the supporting portion 14 and the cover 70 of the electrical connector 10 are brought into electrical contact, thereby allowing for the electrical connector 10 and the cover 70 to be maintained at the same ground potential and making it possible to achieve an improvement in the ground potential of the electrical connector 10. In addition, equalization of the ground potential of the cover 70 can be achieved because this also locally connects the cover 70 to the ground potential of the electrical connector 10.

In the electrical connector 10 according to the present embodiment, there is further provided an electrically conductive resilient member 18 capable of being resiliently compressed by an external force F, and the resilient member 18, upon being resiliently compressed between the connection portion 14a of the supporting portion 14 and the cover 70, provides conduction between the supporting portion 14 and the cover 70. In accordance with the thus-configured present embodiment, when an external force F acting in the direction of mating Z is applied to the resilient member 18 after the electrical connector 10 has brought the resilient member 18 into engagement with the supporting portion 14 provided in the outer conductor 11, the supporting portion 14 can support the external force F through the medium of the resilient member 18. Therefore, when the electrical connector 10 is subjected to an external force F applied by the cover 70 after the circuit board 1 has been covered by the cover 70, it is possible to maintain a state in which the resilient member 18 is resiliently compressed between the supporting portion 14 and the cover 70. As a result, the electrical connector 10 brings the supporting portion 14 and the cover 70 into resilient abutment and makes it possible to electrically connect the electrical connector 10 and the cover 70.

In the electrical connector 10 according to the present embodiment, the resilient member 18 includes a wave washer, a disk spring, a coil spring, a spring washer, a leaf spring, electrically conductive resin, electrically conductive rubber, or electrically conductive foam. In accordance with the thus-configured present embodiment, the resilient member 18 is capable of maintaining a compressed state between the supporting portion 14 and the cover 70 and can ensure good continuity between the outer conductor 11 and the cover 70.

In the electrical connector 10 according to the present embodiment, the supporting portion 14 is a flange expanding radially outwardly from the outer conductor 11 (FIGS. 4, 9 (B)), or a stepped portion 14B formed on the radially outward lateral face of the outer conductor 11 (FIG. 9 (A)). In accordance with the thus-configured present embodiment, the resilient member 18 can be firmly supported using a simple arrangement.

In the electrical connector 10 according to the present embodiment, the outer conductor 11 is configured to permit exposure to the exterior through the attachment opening 71a formed in the cover 70 when the circuit board 1 is covered by the cover 70. In accordance with the thus-configured present embodiment, once the circuit board 1 is covered by the cover 70, the outer conductor 11 is exposed through the attachment opening 71a, which makes it possible to couple a counterpart electrical connector (20, 40) to the electrical connector 10 through the attachment opening 71a without being hindered by the resilient member 18.

In the electrical connector 10 according to the present embodiment, the outer conductor 11 is configured to permit attachment to the circuit board 1 in a manner to be connected to the ground conductor of the circuit board 1, and the cover 70 is also configured to be connected to the ground conductor of the circuit board 1. In accordance with the thus-configured present embodiment, the electrical connector 10, along with being directly connected to the ground conductor of the circuit board 1 via a mount section on the proximal end portion side of the outer conductor 11, can be connected to the common ground conductor via the distal end portion side of the outer conductor 11 through the medium of the cover 70.

In the electrical connector 10 according to the present embodiment, the resilient member 18 is integrally attached to the outer conductor 11. This is preferable because in accordance with the thus-configured present embodiment the resilient member 18 does not get detached from the outer conductor 11 during attachment and detachment of the cover 70.

It should be noted that the individual embodiments of the present invention are not independent and can be implemented as appropriate in combination with one another. In addition, the above-described embodiments are illustrations used to explain the present invention, and the present invention is not limited to these embodiments. The present invention can be implemented in various forms without deviating from the essence thereof.

### INDUSTRIAL APPLICABILITY

The inventive electrical connector can be employed in applications such as connecting coaxial cables and electronic boards used for transmission of radio-frequency signals.

### DESCRIPTION OF THE REFERENCE NUMERALS

1, 2: Circuit boards
1a: Mounting face
9: Coaxial cable
9a: Center conductor
9b: Outer conductor
10: Electrical connector
11: Outer conductor
12: Distal end portion
13: Proximal end portion
14: Supporting portion
14B: Stepped portion
14a: Connection portion
18: Resilient member
20, 40: Electrical connectors
70: Cover
71: Top cover
75: Bottom cover
71a: Attachment opening
72: Upper plate portion
72a: Bottom face
73: Wall portion
74: Accommodating space
100: Electronics module
C: Central axis

1. An electrical connector disposed on a circuit board 1 covered by an electrically conductive cover, the connector comprising:
an electrically conductive tubular outer conductor mounted on the circuit board 1 and extending axially along the direction of mating with a counterpart electrical connector, and
an electrically conductive supporting portion provided in the outer conductor and having a connection portion at the top in the direction of mating,
wherein the connection portion of the supporting portion and the cover are brought into direct or indirect contact when the circuit board is covered by the cover, thereby electrically connecting the electrical connector and the cover.

2. The electrical connector according to claim 1, wherein the connector further comprises an electrically conductive resilient member capable of resilient compression by an external force, and the resilient member, upon being resiliently compressed between the connection portion of the supporting portion and the cover, provides conduction between the supporting portion and the cover.

3. The electrical connector according to claim 2, wherein the resilient member includes a wave washer, a disk spring, a coil spring, a spring washer, a leaf spring, electrically conductive resin, electrically conductive rubber, or electrically conductive foam.

4. The electrical connector according to claim 1, wherein the supporting portion is a flange expanding radially outwardly from the outer conductor or a stepped portion formed on the radially outward lateral face of the outer conductor.

5. The electrical connector according to claim 1, wherein the outer conductor is configured to permit exposure to the exterior through a through-opening formed in the cover when the circuit board is covered by the cover.

6. The electrical connector according to claim 1, wherein the outer conductor is configured to permit attachment to the circuit board 1 in a manner to be connected to a ground conductor in the circuit board, and the cover is also configured to be connected to the ground conductor in the circuit board 1.

7. The electrical connector according to claim 1, wherein the resilient member is integrally attached to the outer conductor.
